(19) United States
(12) Patent Application Publication
(10) Pub. No.: US 2006/0032663 A1
(43) Pub. Date: Feb. 16, 2006

(54) Lid of fuel tank

(75) Inventor: Hajime Hosoya, Takasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD.

(21) Appl. No.: 11/182,189

(22) Filed: Jul. 15, 2005

(30) Foreign Application Priority Data
Jul. 15, 2004 (JP) 2004-208532

(51) Int. Cl. H01B 17/26; H02G 3/06

(52) U.S. Cl. 174/151; 123/497; 220/203.19; 220/241; 220/562; 174/65 R

(57) ABSTRACT

A lid of a fuel tank comprises a lid body constructed of a molded plastic and shaped and sized to be put in an opening formed in a wall of the fuel tank. The lid body has a first portion that is exposed to an outside of the fuel tank when the lid is put in the opening of the wall and a second portion that is exposed to an interior of the fuel tank when the lid is put in the opening of the wall. At least one of the first and second portions has a flat surface for mounting thereon external parts. The lid further comprises a through passage that extends in and through the lid body between the first and second portions. The through passage includes a first passage part terminating at the first portion, a second passage part terminating at the second portion, and a third passage part extending between the first and second passage parts to connect the same. The first and second passage parts are offset in a direction parallel with the flat surface.

### BACKGROUND OF THE INVENTION

1. Field of the Invention

The present invention relates in general to lids of fuel tanks, and more particularly to the lids of a type that has external parts, such as a fuel feed pipe, an electric wiring, a fuel vapor pipe and the like, mounted thereon or therein.

2. Description of the Related Art

In order to clarify the task of the present invention, one conventional lid of such type will be briefly described in the following, which is disclosed in Japanese Laid-open Patent Application (Tokkaihei) 10-299599.

The lid of the publication is constructed and sized to be put in an opening of an automotive fuel tank in a manner to cover the opening. The lid has a fuel feed pipe installed therethrough. In operation, fuel in the tank is led to an engine of the vehicle through the fuel feed pipe. Besides the fuel feed pipe, other external parts, such as electric wiring, fuel vapor pipe and the like tend to be mounted to the lids of the fuel tank. The wiring is used for electrically connecting an electric device in the fuel tank with an electric device arranged outside the fuel tank, and the fuel vapor pipe is used for conveying a fuel vapor produced in the fuel tank to a carbon canister installed in an engine room of an associated motor vehicle.

### SUMMARY OF THE INVENTION

Because of the external parts mounted on or in the lid, it is difficult to provide the lid with a compact or small sized structure, which causes a difficulty in installing an assembly of the fuel tank in a motor vehicle, particularly when the vehicle has a limited space for mounting the assembly. The difficulty in making the lid of such type small also appears when the lid has at its upper side a fuel vapor pipe that is raised from the lid beside another structure raised from the lid. The difficulty becomes much severe when the lid has, at its lower side exposed to an interior of the fuel tank, a fuel limited ventilation valve (viz., FLVV) through which a passage of the fuel vapor pipe is exposed to the interior of the fuel tank.

Accordingly, an object of the present invention is to provide a lid of fuel tank, which can be compact in size irrespective of presence of external parts mounted thereon.

In accordance with a first aspect of the present invention, there is provided a lid of a fuel tank, which comprises a lid body constructed of a molded plastic and shaped and sized to be put in an opening formed in a wall of the fuel tank, the lid body having a first portion that is exposed to an outside of the fuel tank when the lid is put in the opening of the wall and a second portion that is exposed to an interior of the fuel tank when the lid is put in the opening of the wall, at least one of the first and second portions having a flat surface for mounting thereon external parts; and a through passage that extends in and through the lid body between the first and second portions, the through passage including a first passage part terminating at the first portion, a second passage part terminating at the second portion, and a third passage part extending between the first and second passage parts, the first and second passage parts being offset in a direction parallel with the flat surface.

In accordance with a second aspect of the present invention, there is provided a lid of a fuel tank, which comprises a lid body constructed of a molded plastic and shaped and sized to be put in an opening formed in a wall of the fuel tank, the lid body having a first portion that is exposed to an outside of the fuel tank when the lid is put in the opening of the wall and a second portion that is exposed to an interior of the fuel tank when the lid is put in the opening of the wall, at least one of the first and second portions having a flat surface for mounting thereon external parts; a control circuit housing integral with and mounted on the first portion, the housing containing therein a control circuit; a fuel vapor pipe integral with and mounted on the first portion at a position other than the control circuit housing; a fuel vapor passage extending in and through the lid body between the first and second portions, one end of the fuel vapor passage being connected to the fuel vapor pipe; and a fuel limited ventilation valve (FLVV) mounted to the second portion and having an inlet opening to which the other end of the fuel vapor passage is connected, wherein the fuel vapor passage comprises a first passage part terminating at the first portion, a second passage part terminating at the second portion and a third passage part extending between the first and second passage parts to connect the same, the first and second passage parts being offset in a direction parallel with the flat surface.

### BRIEF DESCRIPTION OF THE DRAWINGS

Other objects and advantages of the present invention will become apparent from the following description when taken in conjunction with the accompanying drawings, in which:

FIG. 1 is a schematic illustration of an automotive fuel tank assembly to which a lid of a first embodiment of the present invention is practically applied;

FIG. 2 is an enlarged side view of the lid of the first embodiment of the present invention;

FIG. 3 is a plan view of the lid of the first embodiment of the present invention; and

FIG. 4 is a view similar to FIG. 2, but showing a lid of a second embodiment of the present invention.

### DETAILED DESCRIPTION OF THE INVENTION

In the following, the present invention will be described in detail with reference to the accompanying drawings.

For ease of understanding, various directional terms, such as right, left, upper, lower, rightward and the like are used in the following description. However, such terms are to be understood with respect to only a drawing or drawings on which a corresponding part or portion is shown.

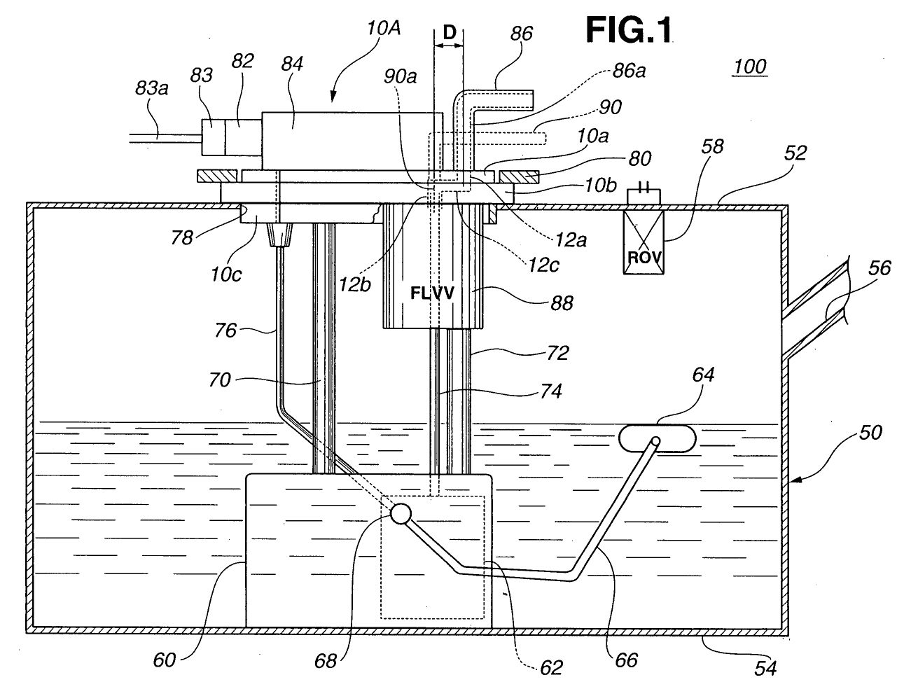

Referring to FIG. 1, there is shown an automotive fuel tank assembly 100 to which a lid 10A of a first embodiment of the present invention is practically applied.

As shown, the automotive fuel tank assembly 100 generally comprises a fuel tank 50 that includes an upper wall 52 and a bottom wall 54. The fuel tank 50 is equipped with a fuel inlet opening 56 into which a fuel feeding nozzle (not shown) of a fuel feeding machine is to be inserted for feeding the fuel tank 50 with a fuel, such as gasoline or the like.

A roll over valve 58 is connected to the upper wall 52, which functions to permit insertion of outside air into the tank 50 in a normal condition and stop dangerous outflow of the fuel to the outside through the valve 58 when, due to rollover of an associated motor vehicle or the like, the fuel tank 50 is turned upside down.

Installed in the fuel tank 50 is a fuel box 60 that is mounted on the bottom wall 54. Within the fuel box 60, there is tightly installed an electric fuel pump 62.

Denoted by numeral 64 is a float that floats in the fuel in the fuel tank 50. The float 64 is connected through an arm 66 to a fuel quantity sensor 68 fixed to the fuel box 60, so that the sensor 68 senses the quantity of the fuel in the tank 50 by measuring the vertical position of the float 64.

From a top of the fuel box 60, there extend two supporting rods 70 and 72 that are led toward the lid 10A of the first embodiment of the present invention in an after-mentioned manner.

From an outlet port of the fuel pump 62, there extends a fuel tube 74 which is led and connected to the lid 10A of the first embodiment, in an after-mentioned manner.

From the electric fuel pump 62 and the fuel quantity sensor 68, there extends a wire harness 76 which is led and connected to the lid 10A, in an after-mentioned manner.

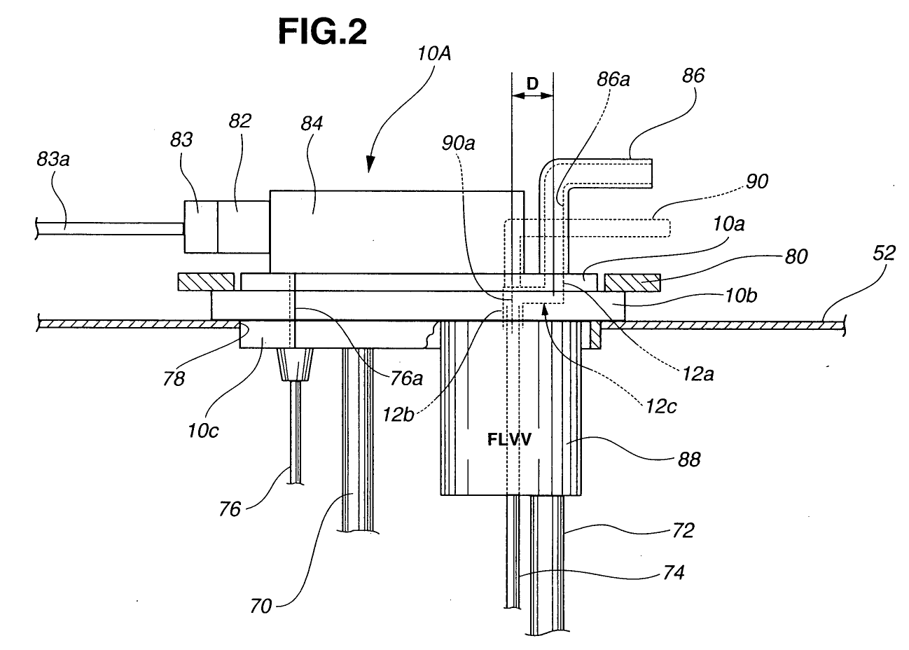

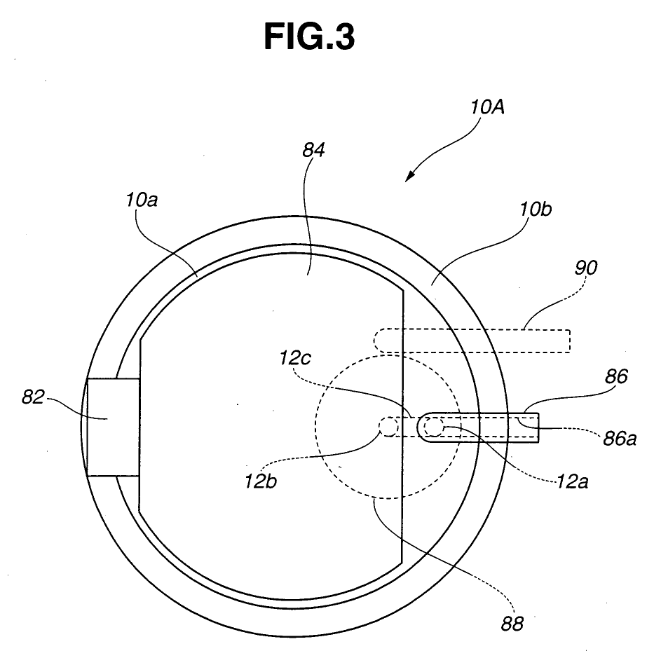

Referring to FIGS. 2 and 3, particularly FIG. 2, there is shown the detail of the lid 10A of the first embodiment of the present invention.

As is seen from FIG. 2, for neatly receiving the lid 10A, the upper wall 52 of the fuel tank 50 is formed with a circular opening 78.

The lid 10A is constructed of a fiber-reinforced molded plastic and generally comprises a cylindrical upper base portion 10a, an annular flange portion 10b concentrically provided by the cylindrical base portion 10a, and a cylindrical lower base portion 10c projected downward from the upper base portion 10a.

It is to be noted that the portions 10a, 10b and 10c are integrated together to constitute a lid body of the lid 10A, which is a single integral construction.

As is seen from FIG. 2, upon setting on the upper wall 52 of fuel tank 50, the cylindrical lower base portion 10c of the lid 10A is neatly received in the circular opening 78 of the upper wall 52 having the annular flange portion 10b seated on a peripheral edge of the opening 78 of the upper wall 52.

For tightly and detachably fixing the lid 10A to the upper wall 52, a lock ring 80 put on the annular flange portion 10b is engaged with a grooved annular bank (not shown) formed on the upper wall 52 around the circular opening 78.

In the first embodiment 10A of the present invention, the following five plastic parts 82, 84, 86, 88 and 90 are integrated to the lid 10A. That is, the above-mentioned portions 10a, 10b and 10c and the following five parts 82, 84, 86, 88 and 90 are all integrated to constitute a single plastic unit that is the lid 10A.

Denoted by numeral 82 in FIG. 2 is a plug housing that is integral with a side portion of a next-mentioned housing 84 for a control circuit. For ease of understanding, the detail of the plug housing 82 will be described after the description of the control circuit housing 84.

The housing 84 for the control circuit is integrally mounted on a flat surface of the upper base portion 10a. As is seen from the drawing, wires 76a are led from the wire harness 76 to the control circuit in the housing 84. Each of the wires 76a is of a plate metal type. Denoted by numeral 77 is a connector that is mounted to the cylindrical lower base portion 10c to detachably connect the wires 76a and the wire harness 76. As shown, the wires 76a extend in and through the lid 10A, more specifically, through the cylindrical upper base portion 10a and the cylindrical lower base portion 10c.

As shown in FIG. 3, the control circuit housing 84 is semicircular in shape when viewed from the above.

Referring back to FIG. 2, the above-mentioned plug housing 82 has therein terminal elements (not shown) to which wires (not shown) extending from the control circuit in the housing 84 are connected. The terminal elements may be of a lead wire type, connector type or land type.

Detachably connected to the plug housing 82 is a socket housing 83 to which a wire harness 83a from an engine control unit, a power source (viz., battery) and the like is connected.

In FIG. 2, denoted by numeral 86 is a fuel vapor pipe that is integral with and raised from a peripheral portion of the cylindrical upper base portion 10a. As will be described in detail hereinafter, an interior 86a of the fuel vapor pipe 86 is communicated with the interior of the fuel tank 50 through a zig-zag passage 12 that extends in and through the lid body of the lid 10A and an after-mentioned fuel limited ventilation valve (viz., FLVV) 88.

Although not shown in the drawings, from the fuel vapor pipe 86, there extends a fuel vapor tube to a carbon canister that is installed in an engine room of the vehicle. That is, a fuel vapor produced in the fuel tank 50 is led to and adsorbed by the carbon canister, and upon operation of an associated engine, the vapor is released from the canister and fed to the intake system of the engine to be burnt.

As shown in FIG. 3, an upper horizontal part of the fuel vapor pipe 86 extends radially outward beyond the periphery of the lid 10A.

Referring back to FIG. 2, denoted by numeral 88 is the fuel limited ventilation valve (FLVV) that has an upper end connected to the cylindrical upper base portion 10a. An upper end of the above-mentioned supporting rod 72 supports the bottom wall of the valve 88 through a spring member (not shown). Like this, an upper end of the other supporting rod 70 supports the lower base portion 10c of the lid 10A through a spring member (not shown).

The fuel limited ventilation valve (viz., FLVV) 88 functions to shut off the passage of the fuel vapor pipe 86 when, under fuel feeding by the fuel feeding machine, the amount of the fuel in the fuel tank 50 reaches a predetermined upper limit level.

As is understood from FIG. 2, for the fluid connection between the fuel vapor pipe 86 and the fuel limited ventilation valve (viz., FLVV) 88, a zig-zag passage 12 is formed in the lid body of the lid 10A.

The zig-zag passage 12 comprises an upper passage part 12a that vertically extends in the lid body to be mated with the passage 86a of the fuel vapor pipe 86, a lower passage part 12b that vertically extends in the lid body to be mated with a center passage of the fuel limited ventilation valve 88, and an intermediate passage part 12c that horizontally extends in the lid body to connect the upper and lower passage parts 12a and 12b.

It is to be noted that such zig-zag shape of the passage 12 allows the fuel vapor pipe 86 to take a peripheral position of the circular lid body of the lid 10A. In other words, as is seen from FIG. 3, even if the housing 84 for the control circuit occupies a considerably larger space on the upper base portion 10a of the lid 10A, setting the fuel vapor pipe 86 on the lid 10A is easily made.

Referring back to FIG. 2, denoted by numeral 90 is a fuel pipe that is illustrated by a dotted line. The fuel pip 90 is integrally mounted on the cylindrical upper base portion 10a beside fuel vapor pipe 86. Although not well shown in the drawings, between a lower end of the fuel pipe 90 and the above-mentioned fuel tube 74, there extends a fuel passage 90a (illustrated by a dotted line) that is formed in and through the cylindrical upper base portion 10a and the cylindrical lower base portion 10c. For detachable connection between the fuel tube 74 and the fuel passage 90a, a connector (not shown) is used. As shown, the fuel passage 90a extends perpendicular to a major flat surface of the lid 10A. That is, in the illustrated example, the fuel pipe 90 is positioned just above an upper end of the fuel tube 74.

As will be understood from FIG. 1, under operation of the associated motor vehicle, the electric fuel pump 62 is controlled by the control circuit installed in the housing 84, which circuit processes various information signals fed thereto through the wire harness 83a. Due to operation of the pump 62, the fuel is fed to the engine through the fuel tube 74, the fuel passage 90a formed in the lid 10A, the fuel pipe 90 raised from the lid 10A and a fuel carrying tube (not shown). Lowering of the float 64 due to reduction of the fuel in the fuel tank 50 is sensed by the sensor 68 and this sensed information on quantity of the fuel is led to the control circuit installed in the housing 84 through the wire harness 76. The roll over valve (viz., ROV) 58 compensates a pressure reduction in the fuel tank 50 by permitting insertion of outside air into the tank 50. However, if, due to turning over, rollover or the like of the vehicle, the fuel tank 50 becomes severely inclined or turned up side down, the valve 58 shuts off the fluid communication between the interior of the tank 50 and the outside of the tank 50. Fuel vapor produced in the fuel tank 50 is led through the fuel limited ventilation valve (FLVV) 88, the fuel vapor pipe 86 and the fuel vapor tube (not shown) to the carbon canister installed in the engine room. When, under fuel feeding by the fuel feeding machine, the amount of the fuel reaches a predetermined upper limit, the fuel limited ventilation valve (FLVV) 88 shuts off the passage of the fuel vapor pipe 86.

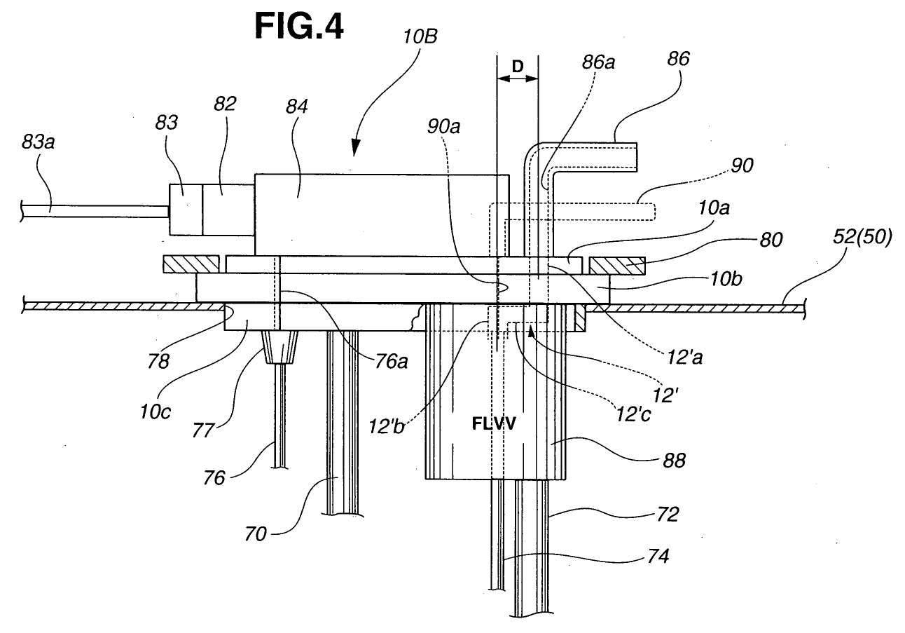

Referring to FIG. 4, there is shown a lid 10B of a second embodiment of the present invention.

Since the lid 10B of this second embodiment is similar in construction to the above-mentioned lid 10A of the first embodiment, only parts or portions that are different from those of the first embodiment 10A will be described in detail in the following.

In this second embodiment 10B, the zig-zag passage 12′ comprises an upper passage part 12′a that vertically extends in the lid body of the lid 10B to be mated with the passage 86a of the fuel vapor pipe 86, a lower passage part 12′b that vertically extends in a body of the fuel limited ventilation valve (FLVV) 88 to be mated with a center passage of the valve 88, and an intermediate passage part 12′c that horizontally extends in the body of the valve 88 to connect the upper and lower passage parts 12′a and 12′b. That is, in this embodiment 10B, a part of the zig-zag passage 12′ is defined by the body of the fuel limited ventilation valve 88. If desired, the intermediate extending passage part 12′c may be a groove that is defined by either one of the lower surface of the cylindrical upper base portion 10a and an upper surface of the body of the fuel limited ventilation valve 88.

As is described hereinabove, in accordance with the present invention, there is used a zig-zag passage 12 or 12′ for connecting the fuel vapor pipe 86 and the fuel limited ventilation valve (viz., FLVV) 88. The zig-zag passage 12 or 12′ comprises the vertically extending upper passage part 12a or 12′a, the vertically extending lower passage part 12b or 12′b and the horizontally extending intermediate passage part 12c or 12′c. Due to provision of the horizontally extending intermediate part 12c or 12′c that has a length of “D”, the position of the fuel vapor pipe 86 can be offset toward the periphery of the lid body of the lid 10A or 10B by the distance “D”. This means that an upper flat area of the upper base portion 10a of the lid 10A or 10B can have a sufficiently large space for mounting thereon various external parts. As is seen from FIG. 3, even when the control circuit housing 84 occupies a marked space on the upper flat area of the lid 10A or 10B, positioning of the fuel vapor pipe 86 on the lid 10A or 10B is easily made for the above-mentioned reason. In other words, the control circuit housing 84, the fuel vapor pipe 86 and the fuel pipe 90 have a higher freedom to take various layout on the upper base portion 10a of the lid 10A or 10B.

In the following, modification of the present invention will be described.

First, if desired, in place of the fuel limited ventilation valve 88, the lid 10A or 10B may be provided with the roll over valve (viz., ROV) 58.

Second, if possible, an outer surface of the lid 10A or 10B may be coated with an oil proof plastic layer.

Third, the plug housing 82 may be a separate member. In this case, the plug housing 82 is secured to the control circuit housing 84 by means of bolts or the like.

fourth, if desired, the two supporting rods 70 and 72 may be secured to the lid 10A or 10B. In this case, the fuel box 60, the fuel pump 62 and the mechanism 66 and 68 of the float 64 constitute a so-called in-tank module that hangs down into the fuel tank 50 from the lid 10A or 10B. Furthermore, if desired, a pressure regulator for regulating a discharge pressure of the pump 62, a fuel filter for filtering the fuel discharged from the pump 62, and a suction filter for filtering the fuel fed to the pump 62 may be installed in the in-tank module.

The entire contents of Japanese Patent Application 2004-208532 filed Jul. 15, 2004 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A lid of a fuel tank, comprising:
a lid body constructed of a molded plastic and shaped and sized to be put in an opening formed in a wall of the fuel tank, the lid body having a first portion that is exposed to an outside of the fuel tank when the lid is put in the opening of the wall and a second portion that is exposed to an interior of the fuel tank when the lid is put in the opening of the wall, at least one of the first and second portions having a flat surface for mounting thereon external parts; and
a through passage that extends in and through the lid body between the first and second portions, the through passage including a first passage part terminating at the first portion, a second passage part terminating at the second portion, and a third passage part extending between the first and second passage parts to connect the same, the first and second passage parts being offset in a direction parallel with the flat surface.

2. A lid as claimed in claim 1, in which the through passage is at least one of a fuel vapor passage and a ventilation passage, the fuel vapor passage being a passage through which a fuel vapor produced in the fuel tank is led to a fuel vapor adsorbing device, and the ventilation passage being a passage that permits insertion of an outside air into the fuel tank.

3. A lid as claimed in claim 2, further comprising a leakage prevention valve that is mounted to the second portion of the lid body to close the through passage when the interior of the fuel tank is subjected to a certain condition.

4. A lid as claimed in claim 1, further comprising a housing that is integral with the first portion of the lid body, the housing containing therein a control circuit.

5. A lid as claimed in claim 3, in which the leakage prevention valve is a fuel limited ventilation valve used for the fuel vapor passage to shut off the passage when the amount of the fuel in the fuel tank reaches a predetermined upper limit level.

6. A lid as claimed in claim 3, in which the leakage prevention valve is a roll over valve used for the ventilation passage to shut off the passage when the fuel tank is inclined by an angle greater than a predetermined angle.

7. A lid as claimed in claim 1, further comprising a fuel passage that extends in and through the lid body between the first and second portions, the fuel passage being a passage through which the fuel in the fuel tank is led to an external device.

8. A lid of a fuel tank, comprising:
a lid body constructed of a molded plastic and shaped and sized to be put in an opening formed in a wall of the fuel tank, the lid body having a first portion that is exposed to an outside of the fuel tank when the lid is put in the opening of the wall and a second portion that is exposed to an interior of the fuel tank when the lid is put in the opening of the wall, at least one of the first and second portions having a flat surface for mounting thereon external parts;
a control circuit housing integral with and mounted on the first portion, the housing containing therein a control circuit;
a fuel vapor pipe integral with and mounted on the first portion at a position other than the control circuit housing;
a fuel vapor passage extending in and through the lid body between the first and second portions, one end of the fuel vapor passage being connected to the fuel vapor pipe; and
a fuel limited ventilation valve mounted to the second portion and having an inlet opening to which the other end of the fuel vapor passage is connected,
wherein the fuel vapor passage comprises a first passage part terminating at the first portion, a second passage part terminating at the second portion and a third passage part extending between the first and second passage parts to connect the same, the first and second passage parts being offset in a direction parallel with the flat surface.

9. A lid as claimed in claim 8, in which all of the first, second and third passage parts are formed in the lid body.

10. A lid as claimed in claim 8, in which the first passage part is formed in the lid body, and second and third passage parts are formed in a body of the fuel limited ventilation valve.

11. A lid as claimed in claim 10, in which the third passage part is a groove that is defined by either one of the second portion and the body of the fuel limited ventilation valve.

12. A lid as claimed in claim 8, further comprising:
a wiring embedded and extending in the lid body, the wiring having one end connected the control circuit in the control circuit housing and the other end connected a wire harness that is led to an electric device installed in the fuel tank; and
a connector housing integral with and connected to the control circuit housing, the connector housing having therein terminal elements that are connected to the control circuit.
